(19) United States
(12) Patent Application Publication
(10) Pub. No.: US 2010/0207932 A1
(43) Pub. Date: Aug. 19, 2010

(54) PLASMA DISPLAY AND DRIVING METHOD THEREOF

(76) Inventors: Seung-Won Choi, Suwon-si (KR); Tae-Jun Kim, Suwon-si (KR); Woo-Joon Chung, Suwon-si (KR); Jin-Hee Jung, Suwon-si (KR)

Correspondence Address: CHRISTIE, PARKER & HALE, LLP, PO BOX 7068, PASADENA, CA, 91109-7068, US

(21) Appl. No.: 12/648,956

(22) Filed: Dec. 29, 2009

Related U.S. Application Data
(60) Provisional application No. 61/153,223, filed on Feb. 17, 2009.

(51) Int. Cl. G06F 3/038; G09G 3/28

(52) U.S. Cl. 345/214; 345/60

(57) ABSTRACT

A plasma display device and a method of driving the same according to the black load of a displayed image. The plasma display device includes a plurality of first electrodes and a plurality of second electrodes extending in parallel, a plurality of pixels each having a plurality of discharge cells defined by the first and the second electrodes, a driver adapted to apply a first reset waveform to the first electrodes and a second reset waveform to the second electrodes during a reset period, and a controller adapted to adjust at least one of a voltage of the first reset waveform or a voltage of the second reset waveform in accordance with a black load of an image signal corresponding to the plurality of pixels.

### CROSS-REFERENCE TO RELATED APPLICATION

This application claims priority to and the benefit of U.S. Provisional Application No. 61/153,223 filed on Feb. 17, 2009 in the United State Patent and Trademark Office, the entire content of which is incorporated herein by reference.

### BACKGROUND OF THE INVENTION

1. Field of the Invention

The present invention relates to a plasma display and a driving method thereof.

2. Description of the Related Art

A plasma display includes a display panel having a plurality of display electrodes and a plurality of cells defined by the display electrodes, and the display panel includes a plurality of pixels. Each pixel includes a plurality of discharge cells, for example, the discharge cells may include a discharge cell of red color, a discharge cell of green color, and a discharge cell of blue color.

The plasma display is driven with one frame (or one field) divided into a plurality of subfields to display an image. Each subfield has a luminance weight and includes a reset period, an address period, and a sustain period. The discharge cells are initialized in the reset period, and discharge cells to be turned on (hereinafter referred to as “on cells”) and discharge cells to be turned off (hereinafter referred to as “off cells”) during the sustain period are selected in the address period. In the sustain period, the on cells are sustain discharged a number of times that corresponds to the luminance weight of the corresponding subfield to display the image.

When a pixel displays a black gray level, the discharge cells included in the pixel are not sustain discharged, but a discharge for an initialization of the discharge cells may be generated in the reset period. As such, luminance of the black gray level may be increased by the light generated by the initialization discharge of the reset period. As a result, the black gray level may be shown brightly. Particularly, this phenomenon may get worse when a lot of pixels display the black gray level among the pixels of the display panel.

### SUMMARY OF THE INVENTION

According to exemplary embodiments of the present invention, a plasma display and a driving method thereof for controlling black luminance in accordance with pixels for displaying black are provided.

According to an aspect of the exemplary embodiments, when the black load of the plasma display is increased, the voltage difference between the display electrodes can be decreased in a reset period such that the black luminance can be reduced. Therefore, when a large number of pixels of the plasma display are selected to display black, the black luminance can be adjusted accordingly to improve the display of black.

According to an embodiment of the present invention, a plasma display device includes a plurality of first electrodes and a plurality of second electrodes extending in parallel, a plurality of pixels each having a plurality of discharge cells defined by the first and the second electrodes, a driver adapted to apply a first reset waveform to the first electrodes and a second reset waveform to the second electrodes during a reset period, and a controller adapted to adjust at least one of a voltage of the first reset waveform or a voltage of the second reset waveform in accordance with a black load of an image signal corresponding to the plurality of pixels.

The black load may correspond to a number of black pixels among the plurality of pixels, and the plurality of discharge cells of one of the black pixels may have gray levels less than corresponding thresholds, respectively.

According to another embodiment of the present invention, a method for driving a plasma display panel (PDP) is provided. The PDP is being driven with a frame divided into a plurality of subfields each including at least a reset period, an address period and a sustain period. The PDP includes a plurality of first electrodes and a plurality of second electrodes extending in parallel, a plurality of third electrodes crossing the first and second electrodes. The PDP further includes a plurality of pixels defined by the first, the second and the third electrodes, each of the pixels including a plurality of sub-pixels.

The method includes: applying reset waveforms to the first, the second and the third electrodes, respectively, to initialize the pixels during the reset period; and applying waveforms to the first, the second and the third electrodes, respectively, to select turn-on pixels among the pixels during the address period and to sustain-discharge the turn-on pixels during the sustain period. According to the method, a voltage waveform applied to at least one of the first electrodes in the reset period is adjusted in accordance with a black load of the PDP, the black load is defined by a ratio of a number of turn-off pixels among the pixels and a number of the plurality of pixels, and each of the sub-pixels of the turn-off pixels has a gray level less than a corresponding threshold value.

According to another embodiment of the present invention, a method for driving a plasma display panel (PDP) is provided. According to the method, the PDP is being driven with a frame divided into a plurality of subfields each including at least a reset period, an address period and a sustain period, the PDP including a plurality of first electrodes and a plurality of second electrodes extending in parallel, a plurality of third electrodes crossing the first and the second electrodes, and the PDP including a plurality of pixels defined by the first, the second and the third electrodes, each of the pixels including a plurality of sub-pixels. According to the method, reset waveforms are applied to the first, the second and the third electrodes, respectively; address waveforms are applied to the first, the second and the third electrodes, respectively, and a pixel black load and a sub-pixel black load are determined; and sustain waveforms are applied to the first, the second and the third electrodes, respectively, to sustain-discharge the pixels. According to the method, a first image and a second image displayed by the PDP have different corresponding reset waveforms when the pixel black load of the first image is different from the pixel black load of the second image while the sub-pixel black load of the first image is substantially equal to the sub-pixel black load of the second image.

According to the embodiment, the first image and the second image displayed by the PDP may have substantially same corresponding reset waveforms when the pixel black load of the first image is substantially the same as the pixel black load of the second image while the sub-pixel black load of the first image is different from the sub-pixel black load of the second image.

The reset waveforms may include a first reset waveform applied to one of the first electrodes and a second reset waveform applied to a corresponding one of the second electrodes, wherein a voltage difference between the first reset waveform and the second reset waveform may gradually increase to a maximum value during a first period of the reset period, and wherein the maximum value may increase when the black load decreases.

### BRIEF DESCRIPTION OF THE DRAWINGS

FIG. 1 is a schematic block diagram of a plasma display according to an exemplary embodiment of the present invention.

FIG. 2 is a graph schematically showing driving waveforms of a plasma display according to an exemplary embodiment of the present invention.

FIG. 3 is a graph showing a relationship between a black luminance and a black load in a plasma display according to an exemplary embodiment of the present invention.

FIGS. 4, 5 and 6 are graphs showing driving methods of a plasma display according to exemplary embodiments of the present invention, respectively.

### DETAILED DESCRIPTION OF EXEMPLARY EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” or “includes” and variations such as “comprises,” “comprising,” “includes,” or “including” will be understood to imply the inclusion of stated elements but not the exclusion of any other elements.

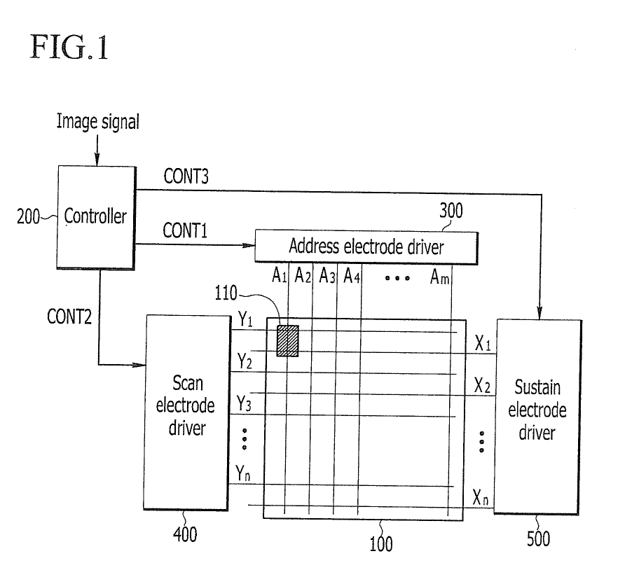

FIG. 1 is a schematic block diagram of a plasma display according to an exemplary embodiment of the present invention.

Referring to FIG. 1, a plasma display includes a plasma display panel 100, a controller 200, an address electrode driver 300, a scan electrode driver 400, and a sustain electrode driver 500.

The plasma display panel 100 includes a plurality of display electrodes Y1 to Yn and X1 to Xn, a plurality of address electrodes A1 to Am (hereinafter referred to as “A electrodes”), and a plurality of discharge cells 110.

The plurality of display electrodes Y1 to Yn and X1 to Xn include a plurality of scan electrodes Y1 to Yn (hereinafter referred to as “Y electrodes”) and a plurality of sustain electrodes X1 to Xn (hereinafter referred to as “X electrodes”). The Y electrodes Y1 to Yn and the X electrodes X1 to Xn extend in a row direction and are substantially parallel to each other, and the A electrodes A1 to Am extend in a column direction and are substantially parallel to each other. Each of the Y electrodes Y1 to Yn may correspond to one of the X electrodes X1 to Xn, one of the Y electrodes Y1 to Yn may correspond to two of the X electrodes X1 to Xn, or one of the X electrodes X1 to Xn may correspond to two of the Y electrodes Y1 to Yn. Here, the discharge cells 110 are formed in the spaces defined by the crossings between the A electrodes A1 to Am, the Y electrodes Y1 to Yn, and the X electrodes X1 to Xn.

Each discharge cell 110 can emit light of one color among primary colors in accordance with the phosphor included in the discharge cell 110. For example, the primary colors include three primary colors such as red, green, and blue. A desired color is displayed by a spatial sum of the three primary colors. In this case, a pixel is a unit for displaying the desired color, and may include a discharge cell (or sub-pixel) for emitting red light (hereinafter referred to as a red discharge cell), a discharge cell (or sub-pixel) for emitting green light (hereinafter referred to as a green discharge cell), and a discharge cell (or sub-pixel) for emitting blue light (hereinafter referred to as a blue discharge cell). In addition, the pixel may further include a discharge cell (or sub-pixel) for emitting white light.

While the above-described plasma display panel 100 illustrates an exemplary embodiment of the present invention, the plasma display panel 100 may have other suitable structures that can be applied.

The controller 200 receives an image signal and an input control signal for controlling the display of the image signal. The image signal includes luminance information of each of the discharge cells 110, and the luminance is defined in terms of a number of gray levels. The input control signal may include a vertical synchronization signal and a horizontal synchronization signal.

The controller 200 divides one frame for displaying an image into a plurality of subfields, each of which has a luminance weight and includes a reset period, an address period, and a sustain period. The controller 200 processes the image signal and the input control signal in accordance with the plurality of subfields, and generates an A electrode driving control signal CONT1, a Y electrode driving control signal CONT2, and an X electrode driving control signal CONT3. The controller 200 outputs the A electrode driving control signal CONT1 to the address electrode driver 300, the Y electrode driving control signal CONT2 to the scan electrode driver 400, and the X electrode driving control signal CONT3 to the sustain electrode driver 500.

The controller 200 transforms the image signal that corresponds to each discharge cell 110 to subfield data that indicate an on/off state of each discharge cell 110 in the plurality of subfields, and the A electrode driving control signal CONT1 includes the subfield data.

The scan electrode driver 400 sequentially applies a scan voltage to the Y electrodes Y1 to Yn in the address period according to the Y electrode driving control signal CONT2. The address electrode driver 300 applies a voltage to the A electrodes A1 to Am for identifying on cells and off cells from the discharge cells coupled to the Y electrodes to which the scan voltage is applied in accordance with the A electrode driving control signal CONT1.

After the on cells and the off cells are identified in the address period, the scan electrode driver 400 and the sustain electrode driver 500 apply sustain pulses to the Y electrodes Y1 to Yn and the X electrodes X1 to Xn a number of times that corresponds to a luminance weight of each subfield during the sustain period in accordance with the Y electrode driving control signal CONT2 and the X electrode driving control signal CONT3.

In addition, the controller 200 calculates the number of pixels for displaying black among all the pixels of the plasma display panel 100 or a ratio of the pixels for displaying black to all the pixels (hereinafter referred to as a black load). The controller 200 controls the A electrode driving control signal CONT1, the Y electrode driving control signal CONT2, and/or the X electrode driving control signal CONT3 in accordance with the black load, and then, controls driving waveforms of the A electrodes A1 to Am, the Y electrode Y1 to Yn and/or the X electrode X1 to Xn in the reset period. When each of the gray levels of image signals corresponding to the discharge cells 110 included in a pixel, for example the red discharge cell (or red sub-pixel), the green discharge cell (or green sub-pixel), and the blue discharge cell (or blue sub-pixel), is less than a threshold value, the pixel displays black. The threshold value is determined by the characteristic of the plasma display panel 100, and may be a value close to zero. The threshold values of the red, green, and blue discharge cells may be respectively determined.

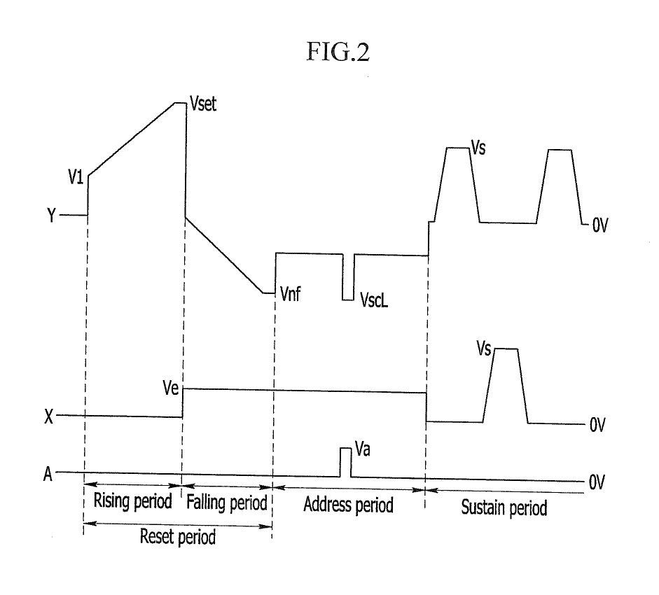

FIG. 2 is a graph schematically showing driving waveforms of a plasma display according to an exemplary embodiment of the present invention.

For the convenience of description, FIG. 2 only shows a single subfield among a plurality of subfields, and the following description is focused on a driving waveform applied to a Y electrode Y, an X electrode X, and an A electrode that define a single cell.

Referring to FIG. 2, in a rising period of a reset period, the scan electrode driver 400 gradually increases a voltage of the Y electrode from a voltage of V1 to a voltage of Vset and then maintains the voltage of the Y electrode at the voltage of Vset during a predetermined period, while the address electrode driver 300 and the sustain electrode driver 500 apply a reference voltage (e.g., 0V in FIG. 2) to the A electrode and the X electrode, respectively. In one embodiment of the present invention, the scan electrode driver 400 may increase the voltage of the Y electrode in a ramp pattern. While the voltage of the Y electrode is gradually increased, a weak discharge is generated between the Y electrode and the X electrode and between the Y electrode and the A electrode. As a result, negative charges may be formed on the Y electrode, and positive charges may be formed on the X electrode and the A electrode. In the embodiment illustrated in FIG. 2, the voltage of V1 may be a voltage of Vs, a voltage of VscH, or the difference (VscH−VscL) between the voltage of VscH and a voltage of VscL that will be further described below. The voltage of Vset may be a sum of the voltage of V1 and a predetermined voltage (e.g., the voltage of Vs).

Subsequently, in a falling period of the reset period, the scan electrode 400 gradually decreases the voltage of the Y electrode from the reference voltage to a voltage of Vnf while the address electrode driver 300 and the sustain electrode driver 500 apply the reference voltage and a voltage of Ve to the A electrode and the X electrode, respectively. In the embodiment of FIG. 2, the scan electrode driver 400 may decrease the voltage of the Y electrode in a ramp pattern. While the voltage of the Y electrode is gradually decreased, a weak discharge is generated between the Y electrode and the X electrode and between the Y electrode and the A electrode such that the negative charges formed on the Y electrode and the positive charges formed on the X electrode and the A electrode may be erased. As a result, the discharge cell is initialized. In the embodiment of FIG. 2, the voltage of Vnf may be a negative voltage, and a voltage (Vnf−Ve) may be set close to a discharge firing voltage between the Y electrode and the X electrode such that the initialized discharge cell may be set to an off cell. In the falling period, the voltage of the Y electrode may be gradually decreased from a voltage different form the reference voltage.

In an address period, in order to identify an on cell and an off cell, the scan electrode driver 400 sequentially applies a scan pulse having a voltage of VscL (i.e., a scan voltage) to a plurality of Y electrodes (Y1 to Yn of FIG. 1) while the sustain electrode driver 500 applies the voltage of Ve to the X electrodes. In addition, the address electrode driver 300 applies a voltage of Va (i.e., an address voltage) to an A electrode of a discharge cell, which will be set to an on-cell, among a plurality of discharge cells defined by the Y electrode to which the voltage of VscL is applied. Accordingly, an address discharge is generated between the A electrode to which the address voltage Va is applied and the Y electrode to which the voltage VscL is applied. As a result, positive charges may be formed on the Y electrode, and negative charges may be formed on the A electrode and the X electrode. In addition, the scan electrode driver 400 may apply the voltage of VscH (i.e., a non-scan voltage), which is higher than the voltage of VscL, to a Y electrode to which the voltage of VscL is not applied, and the address electrode driver 500 may apply the reference voltage to A electrodes to which the voltage of Va is not applied. In the embodiment of FIG. 2, the voltage of VscL may be a negative voltage, and the voltage of Va may be a positive voltage.

In a sustain period, the scan electrode driver 400 and the sustain electrode driver 500 applies a sustain pulse alternately having a high level voltage Vs and a low level voltage (e.g., the reference voltage) to the Y electrode and the X electrode in opposite phases. Thus, when the high level voltage Vs is applied to the Y electrode while the low level voltage is applied to the X electrode, a sustain discharge is generated in the on cell induced by the voltage difference between the high level voltage Vs and the low level voltage. Subsequently, when the high level voltage Vs is applied to the X electrode while the low level voltage is applied to the Y electrode, the sustain discharge is generated again in the on cell induced by the voltage difference between the high level voltage Vs and the low level voltage. This operation is repeated in the sustain period such that the sustain discharge is generated a number of times corresponding to a luminance weight of the corresponding subfield. In another embodiment of the present invention, a sustain pulse alternately having the voltage of Vs and a voltage of −Vs may be applied to one of the Y electrode and the X electrode while the reference voltage is applied to the other.

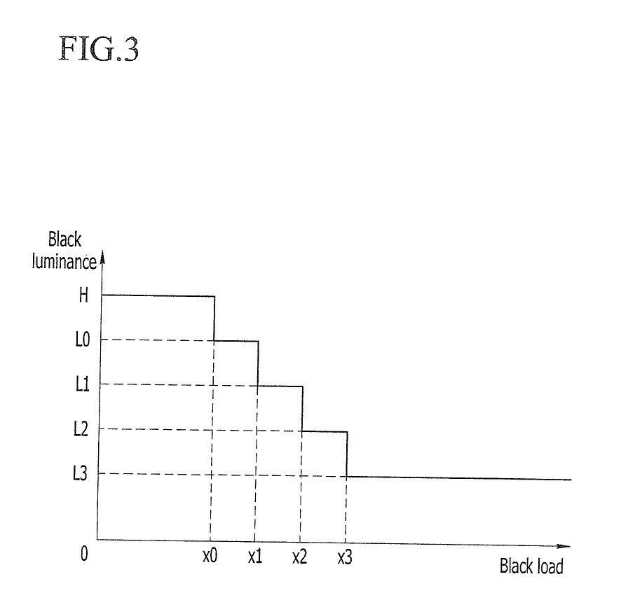

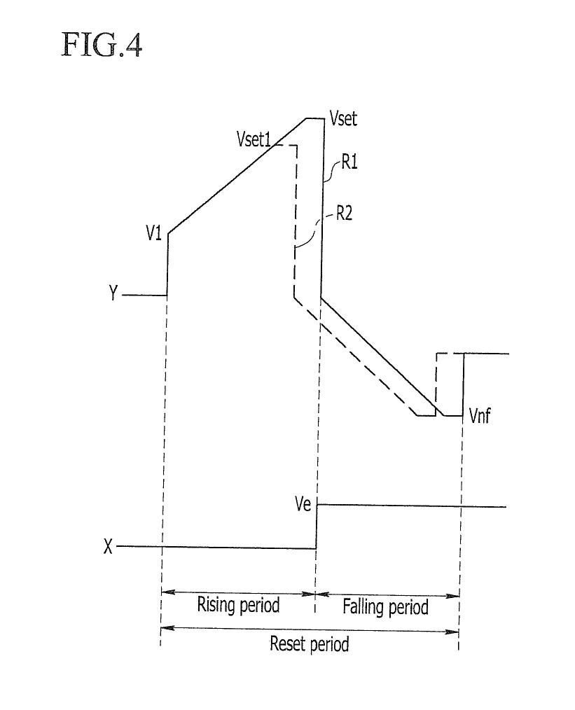

Then, a driving method of a plasma display according to an exemplary embodiment of the present invention will be described in detail with reference to FIG. 3 and FIG. 4.

FIG. 3 is a graph showing a relationship between a black luminance and a black load in a plasma display according to an exemplary embodiment of the present invention, FIG. 4 is a graph showing a driving method of a plasma display according to an exemplary embodiment of the present invention.

Referring to FIG. 3, the controller 200 (shown in FIG. 1) divides a black load into a plurality of regions, generates the A electrode driving control signal CONT1, the Y electrode driving control signal CONT2, and/or the X electrode driving control signal CONT3 for displaying a black luminance in a region having a lower black load to be greater than a black luminance in a region having a higher black load, and the controller 200 transmits the above described control signals to the drivers 300, 400, and 500.

For example, the controller 200 may divide the black load into five regions. The controller 200 may set the black luminance to the highest value H when the black load is between 0 and a reference value x0, set the black luminance to a value L0 that is lower that the value H when the black load is between the reference value x0 and a reference value x1, set the black luminance to a value L1 that is lower than the value L0 when the black load is between the reference value x1 and a reference value x2, set the black luminance to a value L2 that is lower that the value L1 when the black load is between the reference value x2 and a reference value x3, and set the black luminance to a value L3 that is lower that the value L2 when the black load is greater than the reference value x3.

Referring to FIG. 4, when the black load is between 0 and the reference value x0, the scan electrode driver 400 gradually increases a voltage (case R1) of the Y electrode to a voltage of Vset in a reset period in accordance with the Y electrode driving control signal CONT2 from the controller 200. However, when the black load is between the reference values x0 and x1 (x0-x1), the scan electrode driver 400 gradually increases the voltage (case R2) of the Y electrode to a voltage of Vset1 that is lower than the voltage of Vset in accordance with the Y electrode driving control signal CONT2. As a result, an amount of the weak discharge generated while the voltage of the Y electrode is gradually increased is decreased such that a magnitude of light generated in the rising period of the reset period is reduced. In addition, when the amount of the weak discharge in the rising period of the reset period is reduced, an amount of the charges formed on the discharge cell at the end of the rising period is reduced. As a result, an amount of the weak discharge generated in the falling period of the reset period is also reduced such that a magnitude of light generated in the falling period can be reduced.

When a pixel displays black, each of the gray levels of image signals corresponding to discharge cells included in the pixel is less than a threshold value. As a result, a sustain discharge is not generated or is generated a few times in a plurality of subfields included in one frame. Accordingly, when the pixel displays black, the black luminance can be determined or adjusted by the amount of the light generated in the reset period. Since the amount of light generated in the case R2 is less than that in the case R1, the black luminance of the case R2 is less than that of the case R1.

In addition, when the black load is between the reference values x1 and x2 (x1-x2), between the reference values x2 and x3 (x2-x3), and is greater than the reference value x3, the scan electrode driver 400 may gradually increase the voltage of the Y electrode to a voltage of Vset2 that is lower that the voltage of Vset1, a voltage of Vset3 that is lower that the voltage of Vset2, and a voltage of Vset4 that is lower that the voltage of Vset3, respectively. As such, according to an exemplary embodiment of the present invention, when the black load is increased, the voltage difference between the Y electrode and the X electrode is decreased in the rising period of the reset period such that the amount of the weak discharge is reduced in the reset period. As a result, the black luminance of the case that the black load is low can be less than the black luminance of the case that the black load is high.

In an embodiment of the present invention, when the black load is increased, the voltage of the X electrode Ve may be increased while the final voltage Vset of the Y electrode in the rising period is fixed. As a result, the voltage difference between the Y electrode and the X electrode is decreased such that the black luminance is reduced.

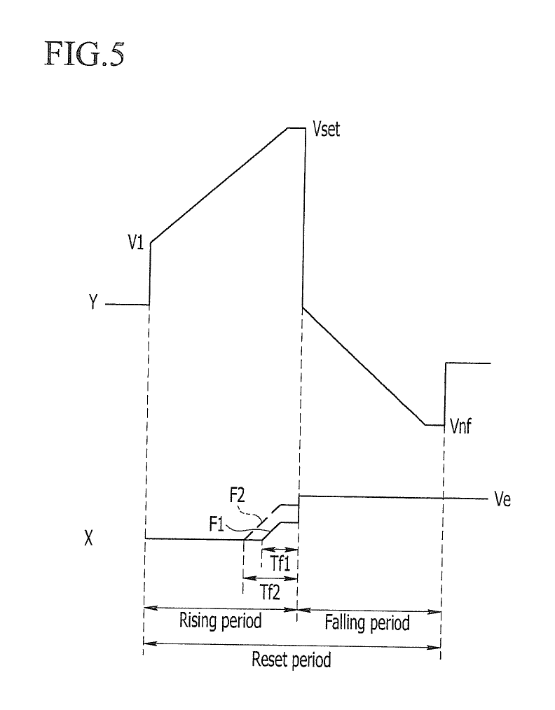

FIG. 5 is a graph showing a driving method of a plasma display according to another exemplary embodiment of the present invention.

Referring to FIG. 5, the sustain electrode driver 500 (shown in FIG. 1) floats the X electrode during a floating period Tf1/Tf2 of a rising period in a reset period in accordance with the X electrode driving control signal CONT3 from the controller 200. Since the X electrode is blocked or not connected from or to a voltage source during the floating period Tf1/Tf2, a voltage of the X electrode is gradually increased or floats higher in accordance with a voltage of the Y electrode by a capacitive component formed by the X electrode and the Y electrode. The floating period Tf1/Tf2 may be an end part or portion of the rising period, that is, a period in which a final voltage is applied in the reset period.

In the embodiment of FIG. 5, the controller 200 sets a floating period Tf2 of the case that the black load is between reference values x0 and x1 (x0-x1) to be longer than a floating period Tf1 of the case that the black load is between 0 and the reference value x0 (0-x0). Then, the voltage (case F2) of the X electrode is increased in accordance with the voltage of the Y electrode during the floating period Tf2 to a final voltage that is higher than a final voltage to which the voltage (case F1) of the X electrode is increased to in accordance with the voltage of the Y electrode during the floating period Tf1. As a result, the black luminance corresponding to the black load between the reference values x0 and x1 (x0-x1) can be less than that corresponding to the black load between 0 and the reference value x0 (0-x0).

In addition, when the black load is between the reference values x1 and x2 (x1-x2), between the reference values x2 and x3 (x2-x3), and is greater than the reference value x3, the controller 200 may set the floating period to a period Tf3 that is longer than the period Tf2, a period Tf4 that is longer than the period Tf3, and a period Tf5 that is longer than the period Tf4, respectively. Accordingly, when the black load is increased, the voltage difference between the Y electrode and the X electrode is decreased in the reset period such that the amount of the weak discharge is reduced in the reset period. As a result, the black luminance of the case that the black load is low can be less than the black luminance of the case that the black load is high.

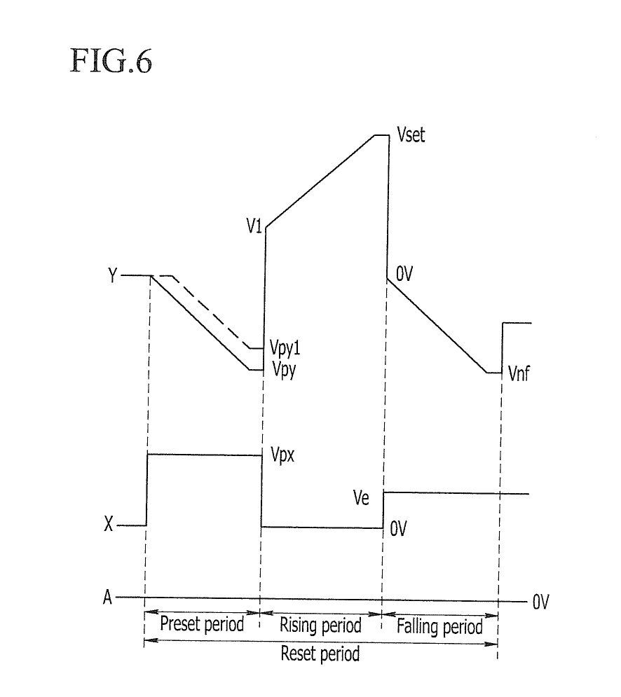

FIG. 6 is a graph showing a driving method of a plasma display according to another exemplary embodiment of the present invention.

In the driving waveforms shown in FIG. 2, since an off cell is not discharged in an address period and a sustain period, the off cell may maintain a charge state which has been set in a reset period. Generally, since a discharge firing voltage between the Y electrode and the X electrode is higher than a discharge firing voltage between the Y electrode and the A electrode, a voltage between the Y electrode and the A electrode may exceed a discharge firing voltage earlier than a voltage between the Y electrode and the X electrode in the off cell when the voltage of the Y electrode is gradually increased in a rising period of the reset period of a next subfield. However, since the A electrode is covered with a phosphor, a delay time for the discharge between the Y electrode and the A electrode is relatively longer in a state that priming particles do not exist in a discharge cell. Accordingly, the discharge between the Y electrode and the A electrode may be not generated at the moment that the voltage between the Y electrode and the A electrode exceeds the discharge firing voltage. The discharge between the Y electrode and the A electrode may be generated after the voltage of the Y electrode is further increased. As a result, the voltage difference between the Y electrode and the A electrode is greater such that a stronger discharge may be generated between the Y electrode and the A electrode.

Therefore, as shown in FIG. 6, the reset period further includes a preset period before the rising period.

In the preset period, the scan electrode driver 400 gradually decreases the voltage of the Y electrode from a reference voltage to a voltage of Vpy while the address electrode driver 300 and the sustain electrode driver 500 apply the reference voltage and a voltage of Vpx to the A electrode and the X electrode, respectively. Alternatively, the voltage of the Y electrode may be gradually decreased from a voltage different from the reference voltage.

In the embodiment of FIG. 6, the difference (Vpx−Vpy) between the voltage of Vpx and the voltage of Vpy may be set to be greater than the voltage difference between the voltage of Ve and the voltage of Vnf (Ve−Vnf). Since the discharge of the off cell has been terminated, in a state that the voltage difference between the Y electrode and the X electrode is the voltage of (Ve−Vnf), in a falling period of the reset period of a previous subfield, the discharge can be generated in the off cell again by setting the voltage difference between the Y electrode and the X electrode to be greater than the voltage of (Ve−Vnf). Accordingly, positive charges are formed on the Y electrode, and negative charges are formed on the X electrode.

When the voltage of the Y electrode is increased in the rising period of the reset period, the weak discharge between the Y electrode and the X electrode can be generated earlier than the weak discharge between the Y electrode and the A electrode by the charges which has been formed during the preset period. As a result, the weak discharge between the Y electrode and the A electrode can be stably generated by priming particles formed by the weak discharge between the Y electrode and the X electrode.

In addition, a final voltage Vpy1 in the preset period of the case that the black load is between reference values x0 and x1 (x0-x1) may be set to be higher than the final voltage Vpy in the preset period of the case that the black load is between 0 and the reference value x0 (0-x0). As a result, the black luminance of the case that the black load is between the reference values x0 and x1 (x0-x1) can be less than that of the case that the black load is between 0 and the reference value x0 (0-x0). In this case, the voltage of (Vpx−Vpy1) may be set to be greater than or equal to the voltage of (Ve−Vnf).

In another embodiment of the present invention, while the final voltage Vpy of the Y electrode in the preset period is fixed irrespective of the black load, the voltage Vpx of the X electrode may be decreased when the black load is increased. Then, the voltage difference between the Y electrode and the X electrode is decreased such that the black luminance is decreased.

According to another exemplary embodiment of the present invention, a combination of at least two of the driving methods described with reference to FIG. 4, FIG. 5, and FIG. 6 may be used.

As described above, according to the exemplary embodiments of the present invention, when the black load is increased, the voltage difference between the Y electrode and the X electrode can be decreased in the reset period such that the black luminance can be reduced. Therefore, when a lot of pixels of the plasma display panel 100 display black, it can be exactly or accurately displayed.

Furthermore, according to another exemplary embodiment of the present invention, a plasma display panel displays a first image and a second image with different reset waveforms when a pixel black load (i.e., number of black pixels/total number of pixels) of the first image is different from a pixel black load of the second image while a sub-pixel black load (i.e., number of black sub-pixels/total number of sub-pixels) of the first image is substantially equal to a sub-pixel black load of the second image. In another embodiment, the first image and the second image have substantially same corresponding reset waveforms when the pixel black load of the first image is substantially the same as the pixel black load of the second image while the sub-pixel black load of the first image is different from the sub-pixel black load of the second image.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display device comprising:
a plurality of first electrodes and a plurality of second electrodes extending in parallel;
a plurality of pixels each having a plurality of discharge cells defined by the first and the second electrodes;
a driver adapted to apply a first reset waveform to the first electrodes and a second reset waveform to the second electrodes during a reset period; and
a controller adapted to adjust at least one of a voltage of the first reset waveform or a voltage of the second reset waveform in accordance with a black load of an image signal corresponding to the plurality of pixels.

2. The plasma display device of claim 1,
wherein the black load corresponds to a number of black pixels among the plurality of pixels, and
wherein the plurality of discharge cells of one of the black pixels have gray levels less than corresponding thresholds, respectively.

3. The plasma display device of claim 1,
wherein the driver is adapted to gradually increase a voltage difference between the first reset waveform and the second reset waveform to a maximum value during a first period of the reset period, and
wherein the maximum value decreases when the black load increases.

4. The plasma display device of claim 3,
wherein a voltage of the first electrodes gradually increases to a maximum voltage by the first reset waveform during the first period, and a voltage of the second electrodes is biased at a bias voltage by the second reset waveform during the first period, and
wherein a difference between the maximum voltage and the bias voltage decreases when the black load increases.

5. The plasma display device of claim 3,
wherein the first period comprises a second period and a third period,
wherein a voltage of the first electrodes gradually increases to a maximum voltage by the first reset waveform during the first period, a voltage of the second electrodes is biased at a bias voltage by the second reset waveform during the second period, and the second electrodes are floated during the third period, and
wherein a duration of the third period increases when the black load increases.

6. The plasma display device of claim 5, wherein the voltage of the first electrodes reaches the maximum voltage during the third period.

7. The plasma display device of claim 3,
wherein the first period comprises a second period and a third period,
wherein a voltage of the first electrodes gradually increases to a maximum voltage by the first reset waveform during the first period, a voltage of the second electrodes is biased at a bias voltage by the second reset waveform during the second period, and a voltage of the second electrodes gradually increases by the second reset waveform during the third period, and
wherein a duration of the third period increases when the black load increases.

8. The plasma display device of claim 3,
wherein a voltage of the first electrodes gradually decreases to a minimum voltage by the first reset waveform during the first period, and a voltage of the second electrodes is biased at a bias voltage by the second reset waveform during the first period, and
wherein a difference between the bias voltage and the minimum voltage decreases when the black load increases.

9. A method for driving a plasma display panel (PDP), the PDP being driven with a frame divided into a plurality of subfields each comprising at least a reset period, an address period and a sustain period, the PDP comprising a plurality of first electrodes and a plurality of second electrodes extending in parallel, a plurality of third electrodes crossing the first and second electrodes, and the PDP comprising a plurality of pixels defined by the first, the second and the third electrodes, each of the pixels comprising a plurality of sub-pixels, the method comprising:
applying reset waveforms to the first, the second and the third electrodes, respectively, to initialize the pixels during the reset period; and
applying waveforms to the first, the second and the third electrodes, respectively, to select turn-on pixels among the pixels during the address period and to sustain-discharge the turn-on pixels during the sustain period, wherein:
a voltage waveform applied to at least one of the first electrodes in the reset period is adjusted in accordance with a black load of the PDP;
the black load is defined by a ratio of a number of turn-off pixels among the pixels and a number of the plurality of pixels; and
each of the sub-pixels of the turn-off pixels has a gray level less than a corresponding threshold value.

10. The method of claim 9,
wherein a maximum value of a first voltage difference between one of the first electrodes and a corresponding one of the second electrodes decreases during a first period of the reset period when the black load increases, and
wherein the maximum value increases when the black load decreases.

11. The method of claim 10, wherein:
while the first voltage difference gradually increases, a voltage of the first electrode gradually increases to a maximum voltage and the second electrode is biased at a bias voltage, and
a difference between the bias voltage and the maximum voltage decreases when the black load increases.

12. The method of claim 10, wherein while the first voltage difference gradually increases during the first period, a voltage of the first electrode gradually increases, and the second electrode is floated during at least a portion of the first period.

13. The method of claim 12, wherein a voltage of the second electrode gradually increases during said portion of the first period in accordance with the black load.

14. The method of claim 12, wherein a duration of said portion of the first period increases when the black load increases.

15. The method of claim 9, further comprising:
gradually increasing a second voltage difference between the first electrode and the second electrode during a second period of the reset period, a maximum value of the second voltage difference being in accordance with the black load.

16. The method of claim 15, wherein a maximum value of the second voltage difference decreases when the black load increases.

17. The method of claim 15, wherein said gradually increasing the second voltage difference between the first electrode and the second electrode comprises:
gradually decreasing a voltage of the first electrode to a minimum voltage; and
biasing the second electrode at a bias voltage,
wherein a difference between the bias voltage and the minimum voltage decreases when the black load increases.

18. A method for driving a plasma display panel (PDP), the PDP being driven with a frame divided into a plurality of subfields each comprising at least a reset period, an address period and a sustain period, the PDP comprising a plurality of first electrodes and a plurality of second electrodes extending in parallel, a plurality of third electrodes crossing the first and the second electrodes, and the PDP comprising a plurality of pixels defined by the first, the second and the third electrodes, each of the pixels comprising a plurality of sub-pixels, the method comprising:
applying reset waveforms to the first, the second and the third electrodes, respectively;
applying address waveforms to the first, the second and the third electrodes, respectively, and determining a pixel black load and a sub-pixel black load; and
applying sustain waveforms to the first, the second and the third electrodes, respectively, to sustain-discharge the pixels,
wherein a first image and a second image displayed by the PDP have different corresponding reset waveforms when the pixel black load of the first image is different from the pixel black load of the second image while the sub-pixel black load of the first image is substantially equal to the sub-pixel black load of the second image.

19. The method of claim 18, wherein the first image and the second image displayed by the PDP have substantially same corresponding reset waveforms when the pixel black load of the first image is substantially the same as the pixel black load of the second image while the sub-pixel black load of the first image is different from the sub-pixel black load of the second image.

20. The method of claim 18,
wherein the reset waveforms comprise a first reset waveform applied to one of the first electrodes and a second reset waveform applied to a corresponding one of the second electrodes,
wherein a voltage difference between the first reset waveform and the second reset waveform gradually increases to a maximum value during a first period of the reset period, and
wherein the maximum value increases when the black load decreases.
